(19) United States
(12) Patent Application Publication
(10) Pub. No.: US 2010/0135674 A1
(43) Pub. Date: Jun. 3, 2010

(54) COMPLEX OPTICAL MODULATION FOR REAL TIME COMMUNICATION

(75) Inventor: Michael J. Hermel, Waseca, MN (US)

Correspondence Address: FOGG & POWERS LLC, 5810 W 78TH STREET, SUITE 100, MINNEAPOLIS, MN, 55439, US

(73) Assignee: ADC TELECOMMUNICATIONS, INC., Eden Prairie, MN (US)

(21) Appl. No.: 12/326,356

(22) Filed: Dec. 2, 2008

(51) Int. Cl. H04B 10/04

(52) U.S. Cl. 398/188

(57) ABSTRACT

Systems and methods for complex optical modulation for real time communication are provided. In one embodiment, a method for real time optical transmission of communications data comprises: generating first in phase (I) and quadrature phase (Q) components of from a first serial bit stream of digitized radio frequency (RF) samples, wherein the digitized RF samples carry a payload of samples of an RF carrier signal which has been modulated with baseband data; modulating an optical signal based on the in phase (I) and quadrature phase (Q) components to produce a complex modulated optical signal; transmitting the complex modulated optical signal over a fiber optic connection; demodulating in real time, second in phase (I) and quadrature phase (Q) components from the complex modulated optical signal; and generating a second serial bit stream of digitized RF samples from the second in phase (I) and quadrature phase (Q) components.

### BACKGROUND

Up until recently, the transport of digital data across optical fiber links has been achieved using binary keying to modulate the digital data onto an optical carrier. As the demand for bandwidth and throughput in communications networks increases, the available capacity of optical fiber links to carry more data becomes strained. Recently, complex optical modulation technologies have emerged that provide for quadrature amplitude modulation (QAM) of optical carriers at rates up to 128 QAM, significantly increasing the data rates possible over optical fiber links by transmitting the same number of symbols per second, but increasing the number of bits per symbol. See, Yoshida et al., 64 and 128 coherent QAM optical transmission over 150 km using frequency stabilized laser and heterodyne PLL detection, Optics Express, Vol. 16, No. 2, pp. 829-840 (21 Jan. 2008). However, the complex optical modulation technologies currently available require both highly precise laser sources and “off line” batch processing to recover the transmitted data. Since even delays of a few micro-seconds can be catastrophic in real time communication networks, the “off line” batch processing used with available complex optical modulation technologies currently prevents their use for real time applications such as in telephone communication networks.

For the reasons stated above and for other reasons stated below which will become apparent to those skilled in the art upon reading and understanding the specification, there is a need in the art for improved systems and methods for real time optical transmission of communications data.

### SUMMARY

The Embodiments of the present invention provide methods and systems for real time optical transmission of communications data and will be understood by reading and studying the following specification.

In one embodiment, a method for real time optical transmission of communications data comprises: generating first in phase (I) and quadrature phase (Q) components of from a first serial bit stream of digitized radio frequency (RF) samples, wherein the digitized RF samples carry a payload of samples of an RF carrier signal which has been modulated with baseband data; modulating an optical signal based on the in phase (I) and quadrature phase (Q) components to produce a complex modulated optical signal; transmitting the complex modulated optical signal over a fiber optic connection; demodulating in real time, second in phase (I) and quadrature phase (Q) components from the complex modulated optical signal; and generating a second serial bit stream of digitized RF samples from the second in phase (I) and quadrature phase (Q) components.

### DRAWINGS

Embodiments of the present invention can be more easily understood and further advantages and uses thereof more readily apparent, when considered in view of the description of the preferred embodiments and the following figures in which:

FIG. 1 is a block diagram illustrating a communication system of one embodiment of the present invention

FIG. 2 is a flow chart of a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide systems and methods for real time transport of digital data using complex optical modulation by translating the digital data into digitized radio frequency (RF) data samples and then modulating an optical carrier with the digitized radio RF data samples using complex modulation techniques. As described below, complex optical modulation modulates an optical carrier using both in phase (I) and quadrature phase (Q) components, commonly referred to as quadrature amplitude modulation (QAM). Embodiments of the present invention enables a communication system to transport communications data over fiber optics at significantly higher data rates than previously available, and recover baseband data in real time.

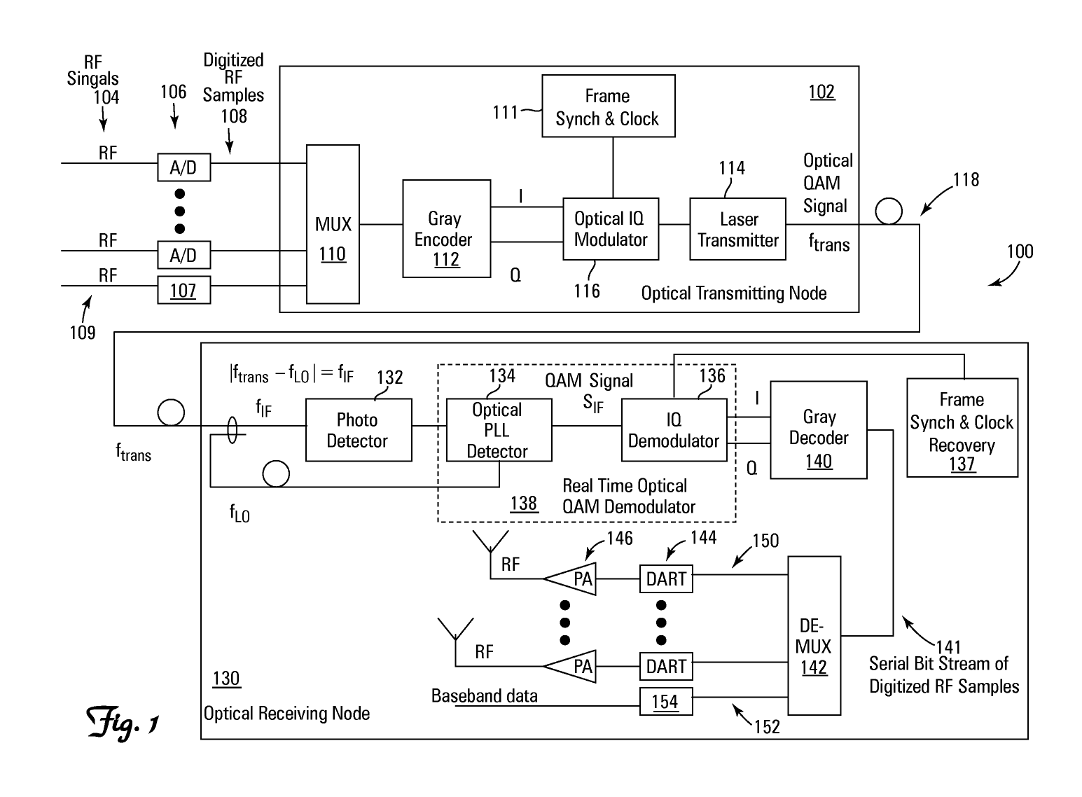

FIG. 1 is a block diagram illustrating a communication system 100 of one embodiment of the present invention. System 100 comprises an optical transmitting node 102 and an optical receiving node 130 linked by a fiber optic medium 1 18. Optical transmitting node 102 comprises an optical IQ modulator 116, a laser transmitter 114, a Gray encoder 112 and a multiplexer (MUX) 110.

In the embodiment shown in FIG. 1, optical transmitting node 102 further comprises a frame synchronization and clock function 111 and optical receiving node 130 includes a frame synchronization & clock recovery function 137. These functions provide the standard clock and data recovery functions which one of ordinary skill in the art upon reading this specification would recognize in serial data transport over optical links.

In operation, optical IQ modulator 116 modulates an optical carrier (i.e., laser light) emitted from laser transmitter 114. The optical carrier is modulation with the I and Q component data produced by Gray encoder 1 12. The resulting output laser transmitter 114 is a complex modulated optical signal such an optical QAM signal. In one embodiment, optical transmitting node 102 includes a QAM coherent optical transmitter as described by the Yoshida et al. article. As shown in FIG. 1, optical transmitting node 102 may receive communication data from more than one incoming data sources (shown generally at 109) as serial bit streams. In that case, MUX 110 receives the multiple serial bit streams, multiplexing them into a single serial bit stream provided to Gray encoder 112.

Before processing by optical transmitting node 102, baseband communications data, from whatever source, is translated into digitized radio frequency (RF) data samples. For example, in one embodiment, baseband communications data is used to modulate a RF carrier wave to produce an analog RF signal (as shown generally at 104). The RF signal 104 is then sampled using an analog to digital converter (A/D) 106 to produce a stream of digitized RF Samples 108, which is provided to MUX 110. In one embodiment, an RF signal 104is received at optical transmitting node 102 as a wireless RF signal, such as from a cellular telephone. In another embodiment, the baseband data is digitally processed by a processor 107 using digital modulation techniques (such as through software defined radio or coherent radio algorithms) to directly generate digitized RF samples 108.

Because the baseband data (that is, the communications payload data which represents voice, video, or other communications data) has been modulated into a RF signal, the communications payload is more resistance to corruption caused by noise or imprecisions of the transmitting, receiving and demodulating process. That is, an RF signal carrying baseband data can withstand a much higher bit error rate (BER) and tolerate more errors and still allow recovery of the payload, when compared to transmitting baseband payload data directly. For example, one of ordinary skill in the art upon reading this specification would appreciate that a BER of 1×10E-15 or better is typically required for transmitting digital data as a pure baseband data stream. In comparison, a BER of 1×10E-5 is very acceptable for transport of RF signals. The increase robustness to processing and transport errors provided by embodiments of the present invention is what enables recovery of data by a receiver in real time, without the need to perform “off line” batch processing.

One of ordinary skill in the art upon reading this specification would further appreciate that the particular underling modulation technique used for producing the RF signals and digitized RF samples 108 is not limited to any one type of RF modulation technique. For example, the RF signals 104 may be created using modulation techniques such as, but not limited to, binary phase shift keying (BPSK), quadrature phase shift keying (QPSK), quadrature amplitude modulation (QAM) or orthogonal frequency division multiplexing (OFDM).

In the embodiment shown in FIG. 1, optical receiving node 130 comprises a photo detector 132, a real time optical QAM demodulator, a Gray decoder 140 and a demultiplexer (DEMUX) 142. Optical receiving node 130 receives the complex modulated optical signal (optical QAM signal) and converts the optical signal from its transmitted frequency (fₜᵣₐₙₛ) to an intermediate frequency (f_{IF}) using a local oscillator signal (f_{LO}) produced by optical PLL detector 134. The intermediate frequency (f_{IF}) optical signal is received by photo detector 132, which produces from the optical signal an electrical signal. The electrical signal is utilized by optical PLL detector 134 for establishing an optical phase lock loop (OPPL). The resulting electrical signal output from optical PLL detector 134 is a QAM signal (S_{IF}) which can be represented by:

S(t)=I(t)·Cos(ω_{IF}t+φ₀)+Q(t)·Sin(ω_{IF}t+φ₀)

IQ demodulator 136 breaks the signal S_{IF} back down into its I and Q components. Gray Decoder 140 receives the I and Q components, converting them in real time into a serial bit stream comprising digitized RF samples (shown generally at 141). The serial bit stream 141 is de-multiplexed by De-MUX 142 into channels of one or more streams of digitized RF samples representative of the digitized RF samples 108 initially received at MUX 110. By employing digitized RF samples to carry baseband payload data, embodiments of the present invention avoid the for high precision in either the transmitting laser or the demodulation process when compared to the present art. The relative relaxation in precision requirements enables the demodulation in real time needed to support real time communication systems such as telephone networks.

In one embodiment, at least one channel of digitized RF sample streams (shown generally at 150) are converted by a digital to analog radio frequency transceiver (DART) module 144 into an analog RF signal which is amplified by a power amplifier 146 for wireless RF broadcast, such as for transmission to a cellular telephone. In another embodiment, at least one stream of the digitized RF samples (shown generally at 152) is digitally processed by a processor 154 using digital modulation techniques (such as through software defined radio or coherent radio algorithms) to directly regenerate digital baseband payload data.

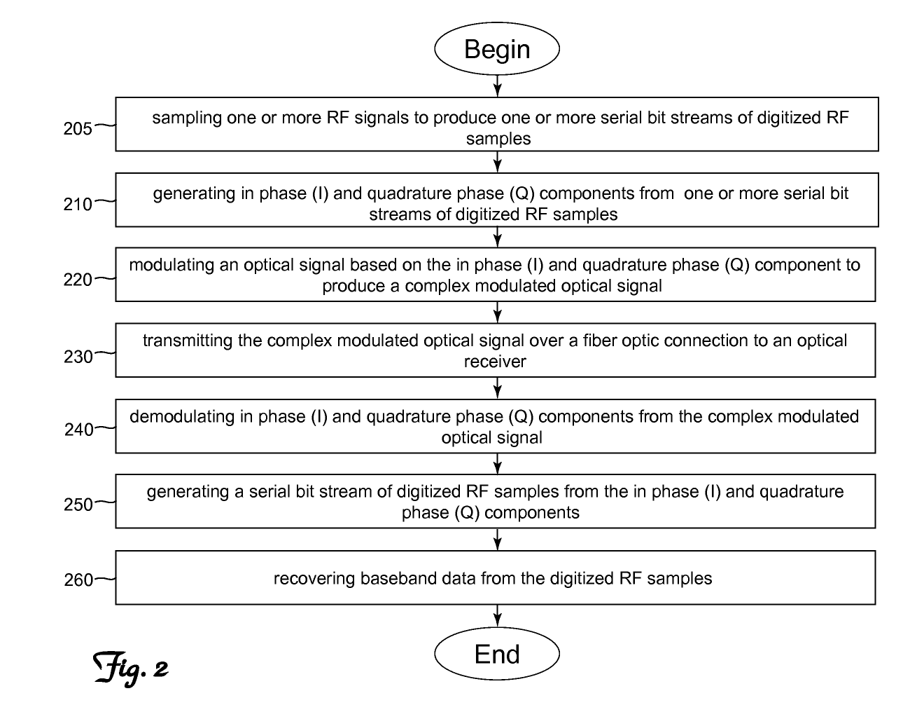

FIG. 2 is a flow chart illustrating a method of one embodiment of the present invention. The method begins at 205 with sampling one or more RF signals to produce one or more serial bit streams of digitized RF samples. The method proceeds to 210 with generating in phase (I) and quadrature phase (Q) components from the one or more serial bit streams of digitized RF samples. The digitized RF samples carry a payload which comprises samples of an RF carrier signal which has been modulated with baseband data. The method continues to 220 with modulating an optical signal based on the in phase (I) and quadrature phase (Q) component to produce a complex modulated optical signal. The method continues to 230 with transmitting the complex modulated optical signal over a fiber optic connection to an optical receiver.

As explained above, because the digitized RF samples carry a payload representing an RF carrier signal modulated with baseband data, the baseband data is relatively resistant to corruption during optical transport caused by noise or other imperfections in the optical carrier generated by the laser source or inaccuracies of the real time demodulation process. Further, to recover the original baseband data, sufficiently accurate reproductions of the digitized RF samples may be generated from the optical carrier using real time demodulation algorithms instead of batch algorithms. For example, wherein a batch algorithm would wait until the receiver receives a complete block of data before processing the data, a real time algorithm processes data as it is received. Even though the real time demodulation algorithm may result in a higher BER in comparison to the batch algorithm, the digitized RF samples are more robust to such higher BERs than the baseband data itself. This means that even with a higher BER introduced by real time optical demodulation of the complex modulated optical signal, the baseband data can still be accurately recovered from the digitized RF samples.

The method thus proceeds to 240 with demodulating in phase (I) and quadrature phase (Q) components from the complex modulated optical signal and to 250 with generating a serial bit stream of digitized RF samples from the in phase (I) and quadrature phase (Q) components. In one embodiment, the serial bit stream is generated by applying the in phase (I) and quadrature phase (Q) components to a Gray decoder.

In one embodiment, the method proceeds to 260 with recovering baseband data from the digitized RF samples. In one embodiment, the digitized RF samples are digitally processed by a processor using digital modulation techniques (such as through software defined radio or coherent radio algorithms) to directly regenerate digital baseband payload data. In another embodiment, the digitized RF samples are converted to an analog radio frequency signal for transmission over a cable, twisted pair, or wireless medium.

Several means are available to implement the systems and methods of the current invention as discussed in this specification. In addition to any means discussed above, these means include, but are not limited to, digital computer systems, microprocessors, programmable controllers, field programmable gate arrays (FPGAs) and application-specific integrated circuits (ASICs). Therefore other embodiments of the present invention are program instructions resident on tangible computer readable media devices which when implemented by such controllers, enable the controllers to implement embodiments of the present invention. Computer readable media devices include tangible devices such as any physical form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method for real time optical transmission of communications data, the method comprising:
generating first in phase (I) and quadrature phase (Q) components of from a first serial bit stream of digitized radio frequency (RF) samples, wherein the digitized RF samples carry a payload of samples of an RF carrier signal which has been modulated with baseband data;
modulating an optical signal based on the in phase (I) and quadrature phase (Q) components to produce a complex modulated optical signal;
transmitting the complex modulated optical signal over a fiber optic connection;
demodulating in real time, second in phase (I) and quadrature phase (Q) components from the complex modulated optical signal; and
generating a second serial bit stream of digitized RF samples from the second in phase (I) and quadrature phase (Q) components.

2. The method of claim 1 further comprising:
recovering the baseband data from the second serial bit stream of digitized RF samples.

3. The method of claim 1 further comprising:
modulating an RF carrier signal with the baseband data; and
sampling the RF carrier signal to generate the first serial bit stream of digitized radio frequency (RF) samples.

4. The method of claim 1 further comprising:
digitally processing the baseband data to generate the first serial bit stream of digitized radio frequency (RF) samples.

5. The method of claim 1 further comprising:
multiplexing a plurality of serial bit streams of digitized radio frequency (RF) samples to produce the first serial bit stream of digitized radio frequency (RF) samples.

6. The method of claim 1 further comprising:
Transmitting the second serial bit stream of digitized RF samples as a wireless RF signal.

7. A system for providing real time optical transport of communications data, the system comprising:
a first node comprising:
a Gray encoder that generates first in phase (I) components and first quadrature phase (Q) components from a first serial bit stream of digitized radio frequency (RF) samples;
a laser transmitter that outputs an optical carrier signal; and
an optical IQ modulator responsive to the Gray encoder, wherein the optical IQ modulator modulates the optical carrier signal based on the first in phase (I) components and the first quadrature phase (Q) components and outputs a complex modulated optical signal to a fiber-optic cable;
a second node comprising:
a photo detector coupled to the fiber-optic cable for receiving the complex modulated optical signal,;
an optical demodulator responsive to the photo detector, the optical demodulator producing second in phase (I) components and second quadrature phase (Q) components in real time as the complex modulated optical signal is received by the photo detector; and
a Gray decoder coupled to the optical demodulator and generating a second serial bit stream of digitized RF samples from the second in phase (I) components and the second quadrature phase (Q) components.

8. The system of claim 7, the second node further comprising:
an optical PLL detector for establishing an optical phase lock loop based on the complex modulated optical signal, wherein the optical PLL detector provides a local oscillator optical signal for generating a intermediate frequency optical signal from the complex modulated optical signal.

9. The system of claim 7, the first node further comprising:
a multiplexer for combining a plurality of digitized RF sample data streams into the first serial bit stream of digitized radio frequency (RF) samples.

10. The system of claim 7, further comprising:
a least one analog to digital converter producing digitized RF samples from a received analog RF signal.

11. The system of claim 7, wherein the optical demodulator further includes an IQ demodulator that executes real time demodulation algorithms for producing the second in phase (I) components and the second quadrature phase (Q) components.

12. The system of claim 7, further comprising:
an RF demodulator for recovering baseband data from the second serial bit stream of digitized RF samples.

13. The system of claim 7, further comprising:
a digital to analog radio frequency transceiver generating an analog RF signal based on the second serial bit stream of digitized RF samples.

14. The system of claim 13, further comprising:
A power amplifier responsive to the digital to analog radio frequency transceiver, the power amplifier generating a wireless RF signal based on the second serial bit stream of digitized RF samples.

15. A communications system comprising:
means for generating first in phase (I) and quadrature phase (Q) components of from a first serial bit stream of digitized radio frequency (RF) samples, wherein the digitized RF samples carry a payload of samples of an RF carrier signal which has been modulated with baseband data;
means for modulating an optical signal based on the in phase (I) and quadrature phase (Q) components to produce a complex modulated optical signal;
means for launching the complex modulated optical signal over a fiber optic connection;
means for demodulating in real time, second in phase (I) and quadrature phase (Q) components from the complex modulated optical signal; and
means for generating a second serial bit stream of digitized RF samples from the second in phase (I) and quadrature phase (Q) components.

16. The system of claim 15, further comprising:
means for recovering the baseband data from the second serial bit stream of digitized RF samples.

17. The system of claim 15, further comprising:
means for modulating an RF carrier signal with the baseband data; and
means for sampling the RF carrier signal, wherein the means for sampling the RF carrier signal generate at least part of the digitized radio frequency (RF) samples of the first serial bit stream of digitized radio frequency (RF) samples.

18. The system of claim 15, further comprising:
means for digitally processing the baseband data to generate the first serial bit stream of digitized radio frequency (RF) samples.

19. The system of claim 15, further comprising:
Means for multiplexing a plurality of serial bit streams of digitized radio frequency (RF) samples to produce the first serial bit stream of digitized radio frequency (RF) samples.

20. The system of claim 15, further comprising:
means for transmitting the second serial bit stream of digitized RF samples as a wireless RF signal.
